(19) United States
(12) Patent Application Publication
(10) Pub. No.: US 2020/0334646 A1
(43) Pub. Date: Oct. 22, 2020

(54) MOBILE TRANSACTION VERIFICATION SYSTEM AND METHOD

(71) Applicant: BOOKTIXNOW LLC, East Brunswick, NJ (US)

(72) Inventors: TIMOTHY DIVITO, CHERRY HILL, NJ (US); JASON GOLDSTEIN, SOUTH RIVER, NJ (US)

(73) Assignee: BOOKTIXNOW LLC, East Brunswick, NJ (US)

(21) Appl. No.: 16/665,494

(22) Filed: Oct. 28, 2019

Related U.S. Application Data
(60) Provisional application No. 62/920,147, filed on Apr. 16, 2019.

(51) Int. Cl. G06Q 20/04; G06Q 20/32; G06Q 20/40; G06Q 10/02; G06Q 50/30

(52) U.S. Cl. CPC G06Q 20/0453; G06Q 20/3227; G06Q 50/30; G06Q 20/401; G06Q 10/02; G06Q 20/3255

(57) ABSTRACT

A system and method for the secure verification of a commercial transaction or of identity in real time and on the fly at a remote location, allowing for, among other things, verification of electronic purchases and payments, for physical entry into a venue for an event, and of the identity of person, regardless of whether or not there is a cost to the goods or services or physical entry being so verified, and without the need for hardcopy tickets or receipts or the use of barcode scanning hardware.

### CROSS REFERENCE TO RELATED APPLICATION

This application claims the benefit of U.S. Provisional Application No. 62/920,147 filed on Apr. 16, 2019.

### FIELD OF INVENTION

The present invention relates to an improved system and method for the secure verification of a commercial transaction or verification of identity on the fly at a remote location, without the need for hardcopy receipts or tickets and without the need for the use of barcode scanning hardware.

### BACKGROUND

The instant invention provides a new method of purchase verification and event entry for event venues and retail locations that allow consumers to use a mobile purchasing system that does not require a printer receipt or the use of barcode scanning technologies that are the current standard practice. The system by which this method is practiced includes changes to the traditional point-of-sale model that has been in place for years. This improved system allows for verification of electronic purchases and payments and facilitates a higher level of security for each such transaction.

### SUMMARY OF THE INVENTION

The mobile transaction verification system and method disclosed herein provides a consumer, or patron, and a business representative with an interactive electronic receipt for goods or services purchased or otherwise requested that includes a number of methods for verification, all of which combine to become a new and innovative approach to redeeming purchases, completing orders, or allowing for entry into a venue without the need for hardcopy receipts or tickets, or for the use of barcode scanning hardware. This system ensures proper redemption of a ticket, order, voucher, or receipt at a location when the transaction was initiated at a location other than the location of redemption or payment was made at such a location prior to the provision of goods or services, or the physical entry by a paying patron into, without limitation, a venue for an entertainment or a sports event. The system includes innovations and specific business processes to ensure a smooth redemption while also increasing customer satisfaction. This new mobile verification system verifies the identity of the person or persons who have been involved in any transaction of goods and services and equally applies to the verification of any type of transaction, regardless of whether or not there is a cost to the goods or services being provided. Hence, the terms consumer, or patron, and business representative may be used herein to describe two parties involved in a commercial transaction, but those terms should not be construed to narrow the breadth of the present invention to situations in which there is an exchange of funds between the parties.

### BRIEF DESCRIPTION OF THE DRAWINGS

The invention will become more readily apparent from the following description of preferred embodiments thereof as shown by way of example only in the accompanying drawings:

FIGS. 1A, 1B, and 1C illustrate typical scenarios for the ordering of goods, services, or entrance tickets.

FIGS. 2A, 2B, and 2C illustrate two scenarios for the ordering of goods, service, or entrance tickets using the system and method of the present invention.

FIG. 3 is a frontal perspective view of a mobile transaction verification pass of the present invention as viewed on a handheld electronic device or smartphone.

FIG. 4 illustrates a ticket redemption scenario using the system and method of the present invention.

FIG. 5 illustrates a purchase redemption scenario using the system and method of the present invention.

FIG. 6 illustrates a mutual identification scenario in the context of a safe and secure ride sharing pickup using the system and method of the present invention.

FIG. 7 illustrates an identification scenario in the context of safe and secure pickup of a child from school using the system and method of the present invention.

### DETAILED DESCRIPTION OF THE INVENTION

The mobile transaction verification system and method disclosed herein provides a consumer, or patron, and a business representative with an interactive electronic receipt for goods or services, or entrance tickets, purchased or ordered, that includes a number of methods for verification, all of which combine in this invention for redeeming purchases or completing orders. This system ensures proper redemption of a ticket, order, voucher, or receipt when payment is made prior to the provision of goods or services, or the physical entry by a paying patron into, without limitation, a venue for an entertainment or a sports event. The system includes innovations and specific business processes to ensure a smooth redemption transaction, while also increasing customer satisfaction and providing a heightened level of transaction security. The mobile verification system of the instant invention is used to verify the identity of the person or persons who have been involved in any transaction of goods and services and equally applies to the verification of any type of transaction, regardless of whether or not there is a cost to the goods or services being provided. Hence, the terms consumer, or patron, and business representative, or the like, may be used herein to describe two parties involved in a commercial transaction, but those terms should not be construed to narrow the breadth of the present invention to situations in which there is an exchange of funds between the parties. This new system provides businesses and consumers with a new and innovative way of verifying the purchase of goods and services at the time of order fulfillment.

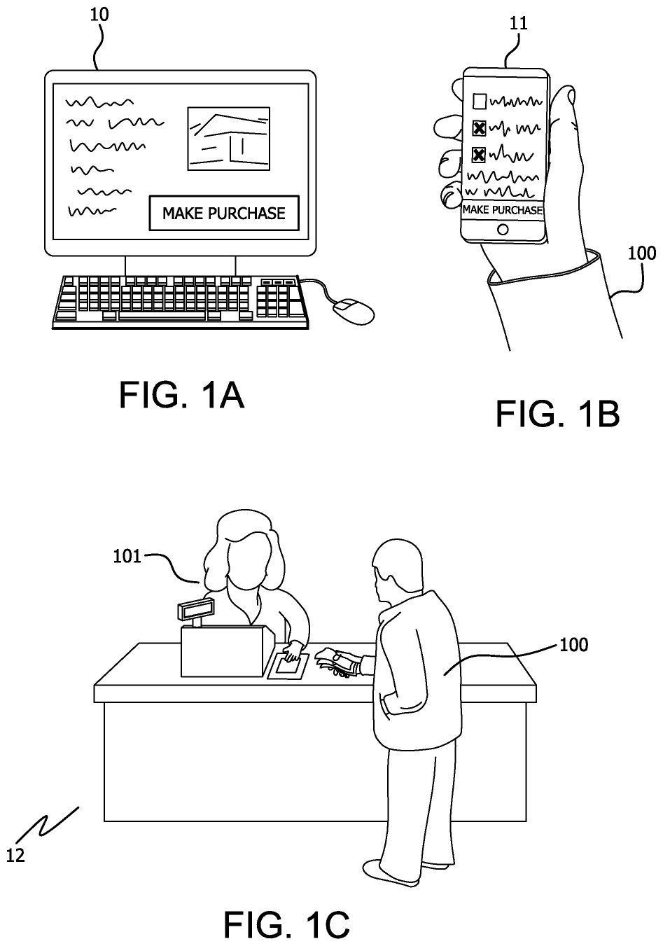

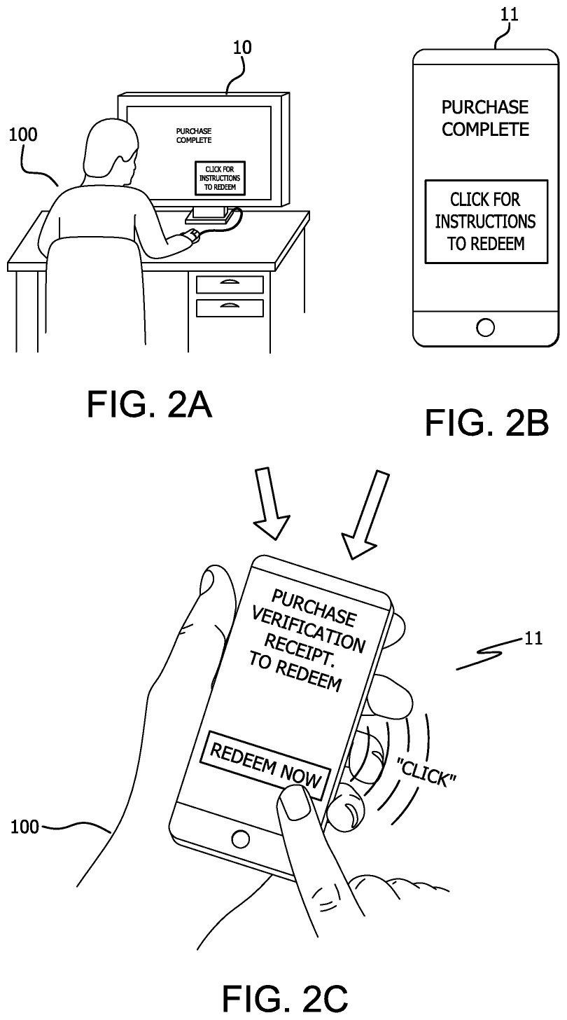

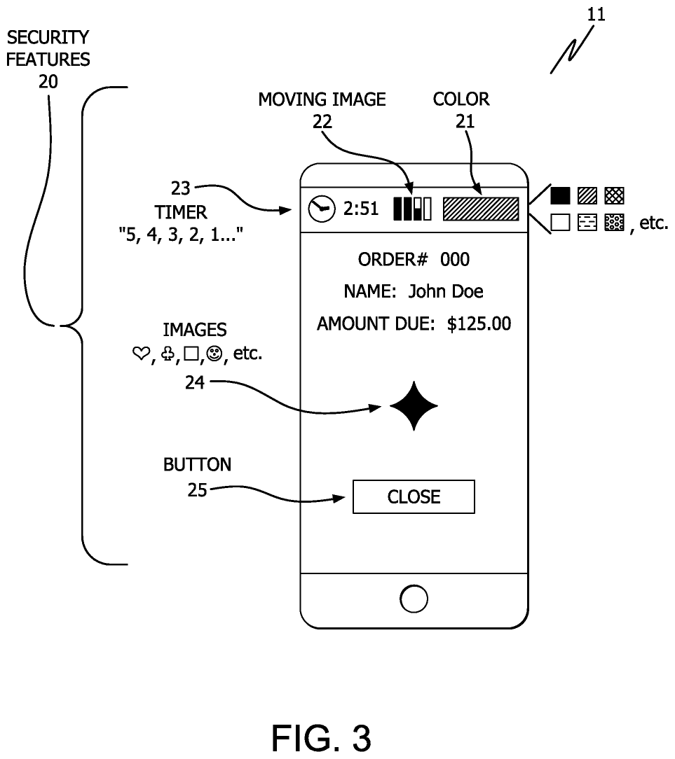

Referring to the drawings, a consumer, or patron, 100 can complete a purchase or an order in typical fashion, for example, on the web using a laptop 10 as in FIG. 1A, using a handheld mobile computing device connected to the internet 11 as in FIG. 1B, or during an in-person transaction with a business representative 101 using a traditional point-of-sale system with a cash register 12. Using the system and method of the instant invention, in the two examples show in FIGS. 2A and 2B, the consumer 100 completes a purchase or an order using either laptop 10 or a smartphone 11 connected to the internet, respectively, is provided with a set of instructions detailing the process of the instant invention for how to redeem the purchase or complete the transaction ordered. This communication with the set of instructions can be sent either in real-time, for example, to the patron 100 at a box office location selling tickets for an event about to start (or at a later time), or to a consumer 100 at a retail store pick-up location at which consumers go to retrieve items previously purchased. Once the patron 100 is ready to redeem his or her purchase by physically being at the location for redemption and has wireless mobile device connected to the internet 11 ready, that patron 100 is prompted to take an action on smartphone 11 as shown in FIG. 2C by clicking on the “Redeem Now” button or icon on the screen of connected device 11. As shown in FIG. 3, that action by consumer 100 initiates on the screen of the handheld device 11 a unique mobile redemption interface that is presented to the business for redemption. The above described communication, or pass, can be an e-mail, an SMS message, or a communication pushed directly to the patron's mobile device via an app or other electronic means. When the patron arrives at the designated redemption location, he or she can start the pickup or entry process by retrieving the link provided to his or her wireless mobile device and confirming that he or she is ready to retrieve their order, or in the case of event entry, enter the event. Before a pass is issued, a confirmation screen is presented to ensure the patron knows he or she must continue only if he or she are physically located at the location specified in the instructions and either ready to receive the purchased items or ready to enter the event.

This system includes changes to current business practices to properly receive patrons at the point of redemption and provide them with the goods or services they purchased. Consumers or patrons can also use this mobile transaction verification system to verify the identity of a business representative who was issued a mobile transaction verification pass as described herein.

Once the patron or consumer 100 has confirmed that he or she are ready, the system issues a mobile transaction verification pass as shown on the screen display of handheld device 11 in FIG. 3. This pass contains a number of optional data elements and security features to ensure that only the proper goods or services are provided to the patron 100. Examples of some of these optional data elements and security features 20 are shown in FIG. 3, including, a specially designed pass with a design pattern not easily replicated as shown thereon, with text and background colors presented in a special color or font 21 specific to that item or performance, a timer 23 counting down to indicate the time remaining for the pass to remain valid, a moving image 22 that indicates that the pass is not a screenshot or some other kind of static image, an image that was selected from the group of possible images 24 based on the time that the pass was generated. FIG. 3 also identifies within the pass an ability for the patron (if directed) to close out the interactive pass to prove it was a genuinely issued pass using button 25, as well as possible additional forms of verification based on the types of goods and services being provided, the industry of the business, and the type of mobile devices being used. There are some additional data elements that may be included in said pass depending on the type of business (including those additional businesses and applications identified herein), such additional data elements including, without limitation, order details related to order cost as well as what goods and services were purchased, the time and or location of the order, and details of the person who placed the order.

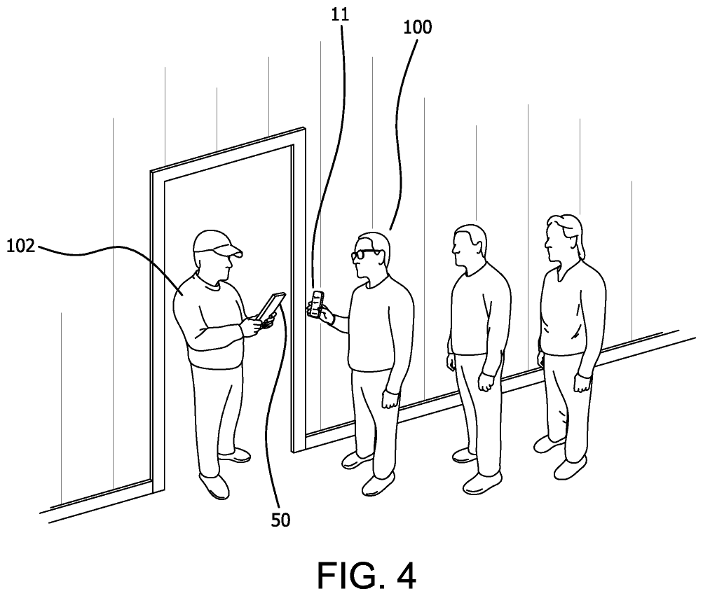

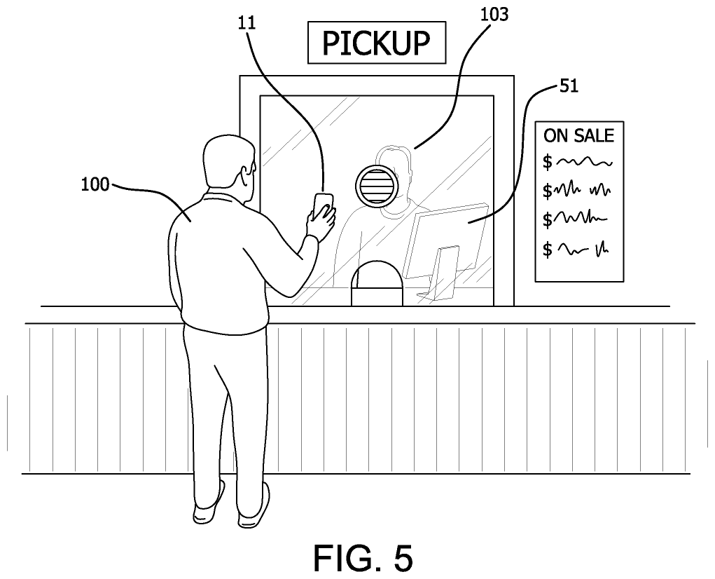

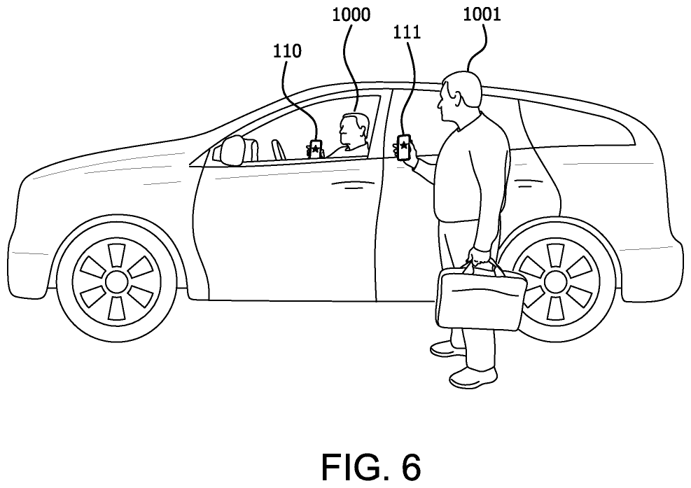

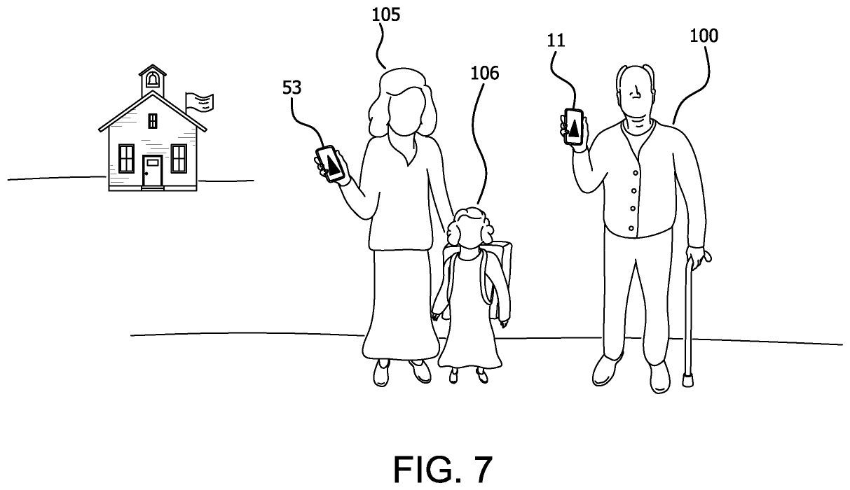

During the verification process, all of the data elements and security features listed in the previous paragraph are then able to be verified by the “business representative” (identified in FIG. 4 as entry guard 102, in FIG. 5 as the dispenser 103 of products, in FIG. 6 as ride share driver 104, and as the teacher 105 in FIG. 7) in providing the goods and services to the patron 100. This can be accomplished in a number of ways based on the preference of the business. In the case in which a business identifies a low risk of patrons attempting to display fraudulent passes, the business can simply issue goods and services based on the pass as displayed by a patron 100. If a greater risk is suspected, a business can choose to verify each pass with data provided using a separate desktop and/or mobile interface, placed at the location of redemption for that business, such as the handheld electronic device 50 held by the guard 102 at the entrance to the venue in FIG. 4, or the display 51 used by the clerk 103 in FIG. 5.

In FIG. 4, a patron 100 standing in a line of those who have purchased tickets for a show or event shows his mobile transaction verification pass on his smartphone 11 to a staff member 102 at the venue who confirms the pass details on the business's mobile device, such as a tablet 50, using the instant verification system. The patron never needed to print a ticket, nor did the business need to scan any kind of barcode. In FIG. 5, a customer 100 has purchased items from a retail store and is showing his mobile device 11 with his mobile transaction verification pass visible thereon to the business representative 103 who is able to confirm the details of the pass using a computing device with a display 51 owned by the business and located at the place of redemption. Once the pass has been verified, the business can then release the items that the patron purchased without any need to print traditional receipts. In both cases, the pass itself is provided as proof of purchase. These verification passes are more secure than paper tickets or receipts that can easily be copied, and easier to administer than scanning barcodes from electronic receipts because they do not require the use of specialized scanning technologies.

FIG. 6 illustrates a scenario by which verification of a business representative/driver 1000 is managed by the consumer/rider 1001. In this example, the consumer/rider 1001 has ordered a pick-up using a popular ride sharing application using his mobile device 111. When the driver 1000 arrives at the designated location, the driver 1000 shows the consumer 1001 his mobile device 110 which displays the mobile transaction verification pass. In this situation, the mobile transaction verification pass was issued to the driver 1000 (business representative), so that the passenger 1001 (consumer) can verify that this is the specific vehicle and driver that was assigned by the ride sharing application and conversely that the driver 1000 can identify the prospective passenger 1001. The issuance of the mobile transaction verification pass has protected the passenger 1001 (consumer) from a fraudulent pick-up by someone falsely claiming to be from the ride sharing service.

FIG. 7 illustrates a verification scenario relating to the identity of a consumer by a business representative. In this example, a parent authorizes a family member to pick-up her daughter 106 from school by issuing a mobile transaction verification pass, which pass is sent to the mobile devicell of the family member 100, in this case the girl's grandfather 100. The grandfather 100 shows the pass on his smartphone 11 to the child's teacher 105 who verifies the pass details on her mobile device 53 before allowing the student to leave with this person. The mobile transaction verification system ensures that the teacher105 is allowing the student 106 to leave with an authorized person, ensuring the safety and security of the child 106.

Current methods of purchasing of goods or services do not include a way to electronically verify that the goods or service have been provided without the use of scanning or some other verification technology. The instant invention of this mobile transaction verification system and method allows for the use of various levels of verification based on the products and industry using the technology, and, as described above, can also be used to verify the identity of either a consumer or business representative to ensure the safety and security of both parties. While the instant invention can be seen as targeted to allow a consumer to present a secure verification pass for proof of purchase or to enter an event or to obtain products or services at a business location, the invention applies as well to the purchase of any good or service when payment is collected before the good or service is provided as well as verify the identity of any party associated with a transaction to ensure the safety and security of all parties involved. Additionally, other applications of this invention can be used in all types of retail sales, health care service delivery, pharmaceutical prescription writing and delivery, medical testing, academic test registration, among others. As may be appreciated, the specification of the invention set forth herein relates in great part to the preferred embodiment of the invention, but other embodiments of the instant invention are also to be understood to be covered hereby.

What is claimed is:

1. A system for secure verification and completion of a sale and purchase transaction at location remote from the initiation of such transaction comprising:
a sending computing device connected to the internet that is controlled by or on behalf of the selling party to said transaction;
a receiving mobile wireless computing device connected to the internet that is controlled by the purchasing party to said transaction;
a sending application program running on said sending device, and
a mobile redemption communication sent by said sending program and received by and visible on the screen of said mobile device providing said purchasing party access to a mobile verification pass visible on said screen,
whereby said mobile verification pass appears as visible on said screen of said mobile device thereby providing authorization to a representative of said selling party at said remote location to complete said transaction with said purchasing party.

2. The system of claim 1 further comprising:
a second computing device connected to the internet that is controlled by said selling party and located at said remote location, being accessible to said representative of said selling party,
whereby the same mobile redemption communication is sent by said sending program and received by and visible on the screen of said second device providing said representative access to a mobile verification pass visible on said screen, thereby allowing said representative to compare said passes on each of said devices for verification to complete said transaction with said purchasing party.

3. The system of claim 1 in which the screen of said mobile device is a touch screen.

4. The system of claim 1 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

5. The system of claim 1 in which said mobile verification pass comprises one or more visible security features.

6. The system of claim 5 in which said one or more visible security features are selected from the group comprising: a timer, moving images, color, transaction information, images, and a touch operable close button.

7. A system for secure verification of a ticket for entrance into a venue remote from the initiation of the transaction for such ticket comprising:
a sending computing device connected to the internet that is controlled by or on behalf of the ticket dispensing party to said transaction;
a receiving mobile wireless computing device connected to the internet that is controlled by the ticket desiring party to said transaction;
a sending application program running on said sending device, and
a mobile redemption communication sent by said sending program and received by and visible on the screen of said mobile device providing said ticket desiring party access to a mobile verification pass visible on said screen,
whereby said mobile verification pass appears as visible on said screen of said mobile device thereby providing authorization to a representative of said ticket dispensing party at said remote location to allow said ticket desiring party entrance into said venue.

8. The system of claim 7 further comprising:
a second computing device connected to the internet that is controlled by said ticket dispensing party and located at said remote location, being accessible to said representative of said ticket dispensing party,
whereby the same mobile redemption communication is sent by said sending program and received by and visible on the screen of said second device providing said representative access to a mobile verification pass visible on said screen, thereby allowing said representative to compare said passes on each of said devices for verification to allow said purchasing party entrance into said venue.

9. The system of claim 7 in which the screen of said mobile device is a touch screen.

10. The system of claim 7 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

11. The system of claim 7 in which said mobile verification pass comprises one or more visible security features.

12. The system of claim 11 in which said one or more visible security features are selected from the group comprising: a timer, moving images, color, transaction information, images, and a touch operable close button.

13. A system for secure verification of the identity of a person comprising:
a sending computing device connected to the internet that is controlled by or on behalf of a first party;
a receiving mobile wireless computing device connected to the internet that is controlled by the person to be identified;
a sending application program running on said sending device, and
a mobile redemption communication sent by said sending program and received by and visible on the screen of said mobile device providing said person to be identified access to a mobile verification pass visible on said screen,
whereby said mobile verification pass appears as visible on said screen of said mobile device thereby providing verification for recognition of said person by a third party.

14. The system of claim 13 further comprising:
a second computing device connected to the internet that is controlled by said third party,
whereby the same mobile redemption communication is sent by said sending program and received by and visible on the screen of said second device providing said third party access to a mobile verification pass visible on said screen, thereby allowing said third party to compare said passes on each of said devices for verification of the identity of said person.

15. The system of claim 13 in which the screen of said mobile device is a touch screen.

16. The system of claim 13 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

17. The system of claim 13 in which said mobile verification pass comprises one or more visible security features.

18. The system of claim 17 in which said one or more visible security features are selected from the group comprising: a timer, moving images, color, transaction information, images, and a touch operable close button.

19. The system of claim 13 in which said third party is in control of the release of a person or thing to be retrieved by said person to be identified.

20. The system of claim 19 in which said first party is a parent of a child to be retrieved by said person to be identified and said third party is selected from the group comprising: a teacher of said child and a person responsible for the safety of said child.

21. A system for secure completion of a transaction between two parties to be completed at a place remote from the initiation of such transaction comprising:
a sending computing device connected to the internet that is controlled by or on behalf of a first party to said transaction;
a receiving mobile wireless computing device connected to the internet that is controlled by a second party to said transaction;
a sending application program running on said sending device, and
a mobile redemption communication sent by said sending program and received by and visible on the screen of said mobile device providing said second party access to a mobile verification pass visible on said screen,
whereby said mobile verification pass appears as visible on said screen of said mobile device thereby providing authorization to a representative of said first party at said remote location to complete said transaction with said second party.

22. The system of claim 21 further comprising:
a second computing device connected to the internet that is controlled by said first party and located at said remote location, being accessible to said representative of said first party,
whereby the same mobile redemption communication is sent by said sending program and received by and visible on the screen of said second device providing said representative access to a mobile verification pass visible on said screen, thereby allowing said representative to compare said passes on each of said devices for verification to complete said transaction with said second party.

23. The system of claim 21 in which the screen of said mobile device is a touch screen.

24. The system of claim 21 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

25. The system of claim 21 in which said mobile verification pass comprises one or more visible security features.

26. The system of claim 25 in which said one or more visible security features are selected from the group comprising: a timer, moving images, color, transaction information, images, and a touch operable close button.

27. In an on demand system controlled by a ride sharing provider in which a potential passenger having a first wireless computing device is paired by said provider with a vehicle driver having a second wireless computing device, the improvement comprising:
a sending computing device connected to the internet that is controlled by or on behalf of said provider;
a sending application program running on said sending device; and
a mobile redemption communication being sent by said sending program and received by and visible on the screen of each of said mobile devices,
whereby said driver and said passenger are provided access to the same mobile verification pass visible on each of said screens for comparison by said passenger so as to verify the identity of said driver.

28. In the improvement of claim 27 the screen of each of said mobile devices is a touch screen.

29. In the improvement of claim 27 said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

30. In the improvement of claim 27 each of said mobile verification passes comprise one or more visible security features.

31. In the improvement of claim 30 said one or more visible security features are selected from the group comprising: a timer, moving images, color, transaction information, images, and a touch operable close button.

32. A method for secure verification of a sale and purchase transaction at location remote from the point of sale comprising the steps of:
selecting a good or service for purchase from a seller at the point of sale by a purchaser;
paying by said purchaser the purchase price for said good or service to said seller at said point of sale;
sending by said seller of a mobile redemption communication to a mobile wireless computing device connected to the internet controlled by said purchaser;
accessing by said purchaser of a mobile verification pass;
visually reviewing by said seller or by a representative of said seller at said remote location of said mobile verification pass visible on the screen of said mobile device controlled by said purchaser, and
completing said transaction at said remote location by said seller or said representative of said seller after verifying said mobile verification pass visible on the screen of said mobile device.

33. The method of claim 32 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

34. The method of claim 32 in which said mobile verification pass comprises one or more visible security features.

35. The method of claim 34 in which said one or more visible security features are selected from the group comprising: a timer, moving images, color, transaction information, images, and a touch operable close button.

36. A method for secure verification of a ticket for entrance into an event at a venue remote from the initiation of the transaction by which such ticket is authorized comprising the steps of:
selecting by a ticket desiring party of an event to be attended;
accepting by a ticket dispensing party of said ticket desiring party for attendance;
sending by said ticket dispensing party of a mobile redemption communication to a mobile wireless computing device connected to the internet controlled by said ticket desiring party;
accessing by said ticket desiring party of a mobile verification pass;
visually reviewing by said ticket dispensing party or by a representative of said ticket dispensing party at said remote location of said mobile verification pass visible on the screen of said mobile device controlled by said ticket desiring party, and
allowing the entrance into said venue of said ticket desiring party at said remote location by said ticket dispensing party or said representative of said ticket dispensing party after verifying said mobile verification pass visible on the screen of said mobile device.

37. The method of claim 36 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

38. The method of claim 36 in which said mobile verification pass comprises one or more visible security features.

39. The method of claim 38 in which said one or more visible security features are selected from the group comprising: a timer, moving images, color, transaction information, images, and a touch operable close button.

40. A method for secure verification of the identity of a person comprising the steps of:
selecting by a first party a person whose identity is to be verified by a second party;
sending by said first party of a mobile redemption communication to a mobile wireless computing device connected to the internet controlled by said person;
sending by said first party of the same mobile redemption communication to a computing device connected to the internet controlled by said second party;
accessing by said person of a mobile verification pass using said communication;
accessing by said second party of said mobile verification pass using said communication;
comparing by said second party of said mobile verification pass visible on the screen of said mobile device controlled by said second party with said mobile verification pass visible on the screen of said mobile device controlled by said person; and
verifying based on such comparison the identity of said person.

41. The method of claim 40 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

42. The method of claim 40 in which said mobile verification pass comprises one or more visible security features.

43. The method of claim 42 in which said one or more visible security features are selected from the group comprising: a timer, moving images, color, transaction information, images, and a touch operable close button.

44. The method of claim 40 in which said third party is in control of the release of a person or thing to be retrieved by said person to be identified.

45. The method of claim 44 in which said first party is a parent of a child to be retrieved by said person to be identified and said third party is selected from the group comprising: a teacher of said child and a person responsible for the safety of said child.

46. A method for secure completion of a transaction between two parties to be completed at a place remote from the initiation of such transaction comprising:
sending by a first party to said transaction of a mobile redemption communication to a mobile wireless computing device connected to the internet controlled by a second party to said transaction;
sending by said first party of the same mobile redemption communication to a computing device connected to the internet controlled by a representative of said first party located at place remote from said place of said initiation of said transaction;
accessing by said first party of a mobile verification pass using said communication;
accessing by said representative of said mobile verification pass using said communication;
comparing by said representative of said mobile verification pass visible on the screen of said mobile device controlled by representative with said mobile verification pass visible on the screen of said mobile device controlled by said second party; and
completing said transaction by said representative with said second party based on such comparison.

47. The method of claim 46 in which said communication is selected from the group comprising: an email showing said mobile verification pass, an SMS message showing said mobile verification pass, a push notification sent directly to an application installed on said mobile device that shows on said screen of said mobile device or allows access to said mobile verification pass, an email with a link to a website on which is shown said mobile verification pass or from which said mobile verification pass may be accessed, an SMS message with a link to a website on which is shown said mobile verification pass or from which said mobile verification pass may be accessed, and an electronic communication showing a mobile verification pass.

48. The method of claim 46 in which said mobile verification pass comprises one or more visible security features.

49. The method of claim 48 in which said one or more visible security features are selected from the group comprising: a timer, moving images, color, transaction information, images, and a touch operable close button.
